(19) United States
(12) Patent Application Publication
(10) Pub. No.: US 2022/0304281 A1
(43) Pub. Date: Sep. 29, 2022

(54) PET WASTE COLLECTION DEVICE

(71) Applicant: Daniel Tibbs, Oakland, MD (US)

(72) Inventor: Daniel Tibbs, Oakland, MD (US)

(21) Appl. No.: 17/347,731

(22) Filed: Jun. 15, 2021

Related U.S. Application Data
(60) Provisional application No. 63/165,915, filed on Mar. 25, 2021.

(51) Int. Cl. A01K 23/00; A01K 27/00

(52) U.S. Cl. CPC A01K 23/00; A01K 27/002

(57) ABSTRACT

A pet harness with an excrement collecting bag holder. The pet harness secures around the front portion, chest girth, and rear portion of a pet, and includes a plastic bag holder positioned at the rear portion to receive plastic waste bags. More specifically, the holder is selectively removably attached to the harness and is configured to be positioned directly under the anus of the pet when the pet squats to defecate. A leak proof waste plastic bag, fastened to the holder, directly receives the excrement of the pet, thereby preventing the excrement from being deposited directly on the ground. The bag holder and waste plastic bag attached thereto do not impede the walking gait of the pet, and the waste plastic bag can be easily attached and detached from the holder.

### CROSS-REFERENCE TO RELATED APPLICATION

The present application claims priority to, and the benefit of, U.S. Provisional Application No. 63/165,915, which was filed on Mar. 25, 2021 and is incorporated herein by reference in its entirety.

### FIELD OF THE INVENTION

The present invention relates generally to the field of devices for feces collection. More specifically, the present invention relates to an improved pet waste collection device comprising a harness with a waste bag holder integrated on the back end of the harness, such that the waste bag holder is designed to receive plastic waste bags. The harness when worn by a pet such as a dog, positions the waste bag in a manner that the pet's excrement is dropped into the waste bag. The invention allows the pet owners to easily collect and dispose the pet's waste and eliminates the need to carry the pet's waste in their hands. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, a majority of the people in the United States and other parts of the world have personal pets that are kept in indoor dwellings. Pets, such as dogs, cats, et. al., can be easily found in nearly every household. Pet owners take their pets on routine walks every day and while walking their pets outside, the pets typically urinate and/or defecate. The waste, such as feces, excreted by pets causes environment pollution and bacterial contamination, both of which can pose health risks to humans and other animals as well. To maintain a sanitary environment, pet owners are required to come in close contact with the excreted feces and must collect it themselves. For the pet owners, picking up pet waste can be an annoying and unsanitary experience.

Typically, pet excrement is picked up by hand in a plastic waste bag and then the full waste bag is carried in hand while walking the pet toward a waste receptacle to deposit the waste bag. Also, to collect the pet waste excreted on the ground, pet owners are required to bend or squat down. Elderly people and people with limited dexterity may have difficulty and may be uncomfortable bending over to collect the waste excreted on the ground. Currently, the pet waste collection experience is quite annoying and frustrating for the pet owners.

Various devices are available in the market that assist the pet owners in picking up the pet waste, and eliminate the need to use their hands for collecting the pet waste. For example, a dog poop scooper is a device that allows the users to use a plastic bag and clip it to the waste collection end of the device, and then squeeze its handle to open the waste collection end to pick up the waste excreted on the ground. Although the device prevents the users from bending over and assists in picking up pet waste, the pet owners are required to carry the dog poop scooper devices along with them while walking the pets. Carrying the dog poop scooper device on the walk, and using it when the dog excretes the feces onto the ground is an annoying job. People may not be comfortable carrying the dog poop scooper device while walking their pets. Additionally, once the feces is collected in the plastic bag clipped to the device, the pet owners are still required to carry the bag full of pet waste while walking the pet. Currently available solutions do not improve the pet waste collection experience for pet owners.

Therefore, there exists a long-felt need in the art for a device that helps in picking up the waste excreted by pets such as dogs, cats and the like. There is also a long-felt need in the art for a device that does not require the pet owners to come in close contact with the pet waste to collect it. Additionally, there is a long-felt need in the art for a device that can be easily used with pets such as dogs, cats and more for collecting pet waste such as feces while going for routine walks. Moreover, there is a long-felt need in the art for a device that eliminates the need to carry a bag full of waste material while walking. Further, there is a long-felt need in the art for a solution that eliminates the need for pet owners to carry a device while walking their pets. Furthermore, there is a long-felt need in the art for a pet waste collection device that reduces the risk of unsanitary material getting on the hands of owners while walking a pet. Finally, there is a long-felt need in the art for a device that improves the overall pet waste collection experience for the pet owners.

The subject matter disclosed and claimed herein, in one embodiment thereof, comprises a dog harness with an excrement-collecting bag holder. The dog harness is configured and dimensioned to secure around the front portion, chest girth and rear portion of a dog with a receptacle holder positioned at the rear portion to receive plastic waste bags. The dog harness further comprises a neck or shoulder strap to snugly fit around the neck or shoulders of a dog, a back strap and chest strap to fit around the back and chest girth area, a rear strap to wrap around the thighs and rump and a tail strap to circumscribe around the tail of the dog. More specifically, a receptacle or bag holder is attached to the harness and is configured to be positioned directly under the anus of the dog when the dog squats to defecate. A leak-proof plastic waste bag fastened to the holder directly receives the excrement of the dog, thus prohibiting the excrement from dropping on the ground. The waste plastic bag does not impede the walking gait of the dog, and can be easily attached and detached from the holder.

In this manner, the pet waste collection device of the present invention accomplishes all of the forgoing objectives, and provides a relatively safe and convenient solution to pick up and collect the waste excreted by pets such as dogs, cats and more. The pet waste collection device of the present invention is also user friendly, as the users can easily attach and detach the bags in the waste bag holder of the device. Additionally, the pet waste collection device does not require the users to bend over or squat to pick up waste excreted on the ground, as the waste is collected in the waste bag before it hits the ground. Therefore, the pet waste collection device eliminates the need to carry a ‘full’ waste bag in hand while walking the pet and improves the overall pet waste collection experience for the pet owners and other individuals.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dog harness with an excrement-collecting bag holder. The dog harness is configured and dimensioned to secure around the front portion, chest girth and rear portion of a dog with a receptacle holder positioned at the rear portion to receive plastic waste bags. The dog harness further comprises a neck or shoulder strap to snugly fit around the neck or shoulders of a dog, a back strap and chest strap to fit around the back and chest girth area, a rear strap to wrap around the thighs and rump (or the belly) and a tail strap to circumscribe around the base of the tail of the dog. More specifically, a receptacle or bag holder is attached to the harness and is configured to be positioned directly under the anus of the dog when the dog squats to defecate. A leak-proof waste plastic bag fastened to the holder directly receives the excrement of the dog, thus prohibiting the excrement from dropping on the ground. The waste plastic bag does not impede the walking gait of the dog and can be easily attached and detached from the holder.

In a further embodiment of the present invention, a dog excrement holder that is removably attached to a dog harness is disclosed. The dog excrement holder includes a pair of straps connected to the holder that are configured to attach to a rear portion of a dog harness. The holder is configured to receive a plastic waste bag to catch dropped excrement of the dog. The holder, when attached to the dog harness, is positioned directly underneath the anus of the dog such that the excrement is dropped directly into the waste plastic bag. The waste plastic bag can be clipped, fastened with hook and loop fastener or attached via any other retention mechanism for securing the bag to the holder device.

In a further embodiment of the present invention, the waste plastic bags can be attached and detached easily from the holder, eliminating the need to carry the bags separately. The dog harness is constructed using a soft and stretchable material like nylon, soft rubber, or silicone. The holder device does not impede the movement of the dog.

In yet a further embodiment of the present invention, a harness device for catching excrement of a pet is described. The harness device is adjustable to fit small, medium and large dogs. The harness device is designed as one-piece unit with a neck and shoulder strap, a back and chest girth strap, a rear strap and a tail strap. A waste-collecting holder configured to receive plastic waste bags extends from the rear strap and is positioned underneath the anus of the pet to directly receive the excrement of the dog. A used plastic waste bag can be detached easily and replaced with a new plastic bag as needed.

The harness is comfortable for pets of different sizes. The straps of the harness are designed to be adjusted to fit snugly but not too tightly. The harness eliminates the need for the pet owner to carry a poop scooper or other devices. The harness can have a pocket, tube or compartment in which the waste plastic bags can be stored, eliminating the need for the pet owner to carry the bags.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pet waste collection harness of the present invention in accordance with the disclosed architecture;

FIG. 2 illustrates a perspective view of a dog wearing one potential embodiment of the pet waste collection harness of the present invention in accordance with the disclosed architecture;

FIG. 3 illustrates a perspective view of a disposable plastic bag attached to one potential embodiment of the waste collection holder receiving dog waste in accordance with the disclosed architecture; and

FIG. 4 illustrates a rear perspective view of a pet wearing one potential embodiment of the pet waste collection device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that helps in picking up the waste excreted by pets such as dogs, cats and the like. There is also a long-felt need in the art for a device that does not require the pet owners to come in close contact with the pet waste to collect it. Additionally, there is a long-felt need in the art for a device that can be easily used with the pets such as dogs, cats and more for collecting pet waste such as feces while going for routine walks. Moreover, there is a long-felt need in the art for a device that eliminates the need for pet owners to carry a bag full of waste material while walking. Further, there is a long-felt need in the art for a device that eliminates the need to carry the device by the pet owners while walking with the pets. Furthermore, there is a long-felt need in the art for a pet waste collection device that reduces the risk of unsanitary material getting on the hands of pet owners while walking a pet. Finally, there is a long-felt need in the art for a device that improves the overall pet waste collection experience for the pet owners.

The present invention, in one exemplary embodiment, comprises a novel dog harness with an excrement-collecting bag holder. The dog harness is configured and dimensioned to secure around the front portion, chest girth and rear portion of a dog, with a receptacle holder positioned at the rear portion to receive plastic waste bags. The dog harness further comprises a neck or shoulder strap to snugly fit around the neck or shoulders of a dog, a back strap and chest strap to fit around the back and chest girth area, a rear strap to wrap around the thighs and rump and a tail strap to circumscribe around the tail of the dog. More specifically, a receptacle or bag holder is attached to the harness and is configured to be positioned directly under the anus of the dog when the dog squats to defecate. A leak-proof plastic waste bag fastened to the holder directly receives the excrement of the dog, thus prohibiting the excrement from dropping on the ground. The plastic waste bag does not impede the walking gait of the dog, and can be easily attached and detached from the holder.

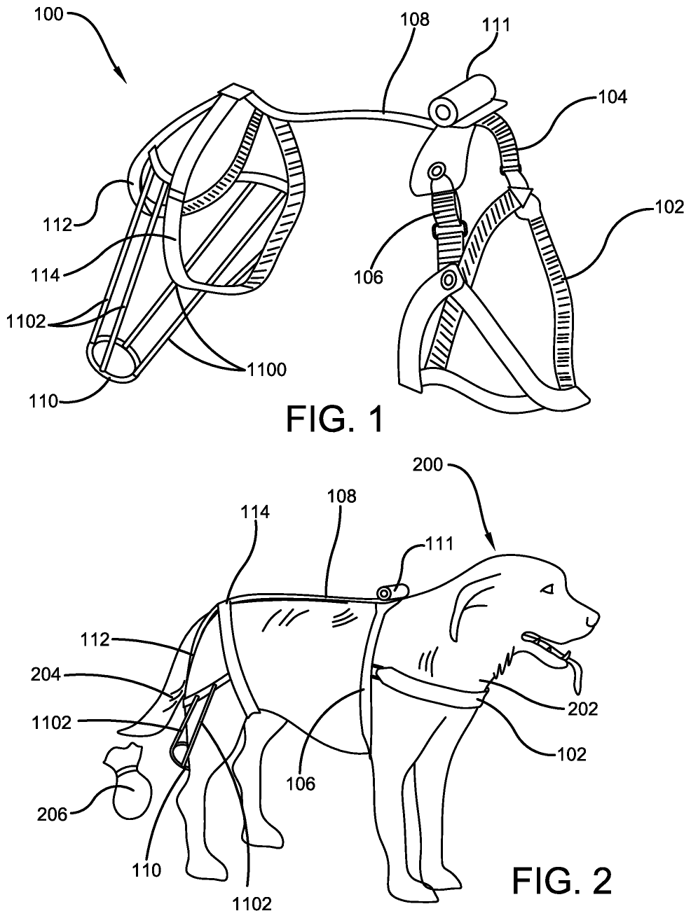

Referring initially to the drawings, FIG. 1 illustrates a perspective view of one potential embodiment of a dog waste collection harness of the present invention in accordance with the disclosed architecture. The dog waste collection harness 100 is a comfortable harness for dogs designed to collect excrement of a pet such as dog. A dog leash (not illustrated) can also be connected to a handle 111 of the harness 100 for easily controlling the dog. The dog harness 100 comprises a one-piece unit made up of soft and flexible material such as nylon, though other materials such as leather, fabric, plastic, etc. may also be used. The harness 100 has a V-shaped neck and front shoulder strap 102 to provide support between the neck and shoulders of a dog. The harness further comprises two stretchable buckled arm straps 104, 106 connecting the neck strap 102 and a back strap 108. The harness 100 further comprises a handle 111 for grasping the harness, or for receiving a leash, to enable restraint and control of the pet. The straps 102, 104, and 106 are stretchable to adapt the harness 100 to relatively large chested dogs compared to overall size, for example, a Doberman/Husky blend, Teddy, Bulldog, Chihuahua, Miniature Pinscher, Schnauzer, Samoyed and more. To adapt to smaller dogs, the size of the harness 100 can be proportioned and adjusted accordingly.

A rear strap 114 can be connected to the back strap 108 and is configured and designed to strap around the rear portion of a dog, such as the thighs and rump or alternatively around the belly or abdomen. A tail strap 112 is provided to accommodate and circumscribe the tail of a dog, and to provide an additional strap to maintain the proper orientation and position of the harness 100. The tail strap 112 is in the shape of a loop and circumscribes the base of the dog's tail. A novel dog waste collecting holder 110 is connected to the bottom strap 114 using removable retention straps 1100, 1102. The retention or hanging straps 1100, 1102 are selectively-removable from the rear or bottom strap 114. The dog harness 100 can be made of a soft material such as nylon, rubber or silicone, and includes adjustment points for the bottom strap 114, back strap 108 and the neck strap 102 to fit dogs of different sizes. The tension of the straps comprising the harness 100 can be evenly distributed to prevent pulling and discomfort of the dog wearing the harness.

The waste-collecting holder 110 is configured and designed to receive plastic waste bags 206 which can be secured to the holder 110 using a clip attachment or other retention mechanism. The plastic waste bag 206 secured to the holder 110 receives the excrement of the dog therein, and collects the waste before it hits the ground. A plastic bag 206 can be attached to the holder 110 before going for a walk with the dog and can be removed once the excrement is collected in the plastic bag 206.

The plastic bag 206 can be fastened to the waste-collecting holder 110 using a knot or a hook and loop fastener. The plastic bags 206 can be commercially available with the harness 100 or alternatively, conventional plastic bags 206 can be used with the harness 100. The harness 100 can be secured safely and comfortably on the front and rear part of the dog. The harness 100 is easy to mount and remove from the dog.

FIG. 2 illustrates a perspective view of a dog wearing the waste-collection harness of the present invention in accordance with the disclosed architecture. The dog harness 100 is worn by a dog 200 around the neck and shoulder portion, back portion and rear portion with a snug adjustable fit. The neck strap 102 fits snugly around the neck and shoulder area 202 of the dog 200, the back strap 108 covers the chest girth portion of the dog 200 and the rear strap 114 fits around the thighs and rump of the dog 200.

The tail strap 112 fits snugly under and around the base of the tail 204 to assist with centering the rear of the harness and to assist with centering the waste collection holder 110 under the anus of the dog 200. The waste collection holder 110 is configured to be hung using the retention or hanging straps 1100, 1102. and is configured to be in a position under the anus of the dog 200. The retention straps 1100, 1102 are selectively-removable from the rear strap 114. A disposable plastic bag 206 can be fastened to the waste collection holder 110 for collecting the waste of the dog 200 using a fastening mechanism such as clip mechanism or hook and loop fastener.

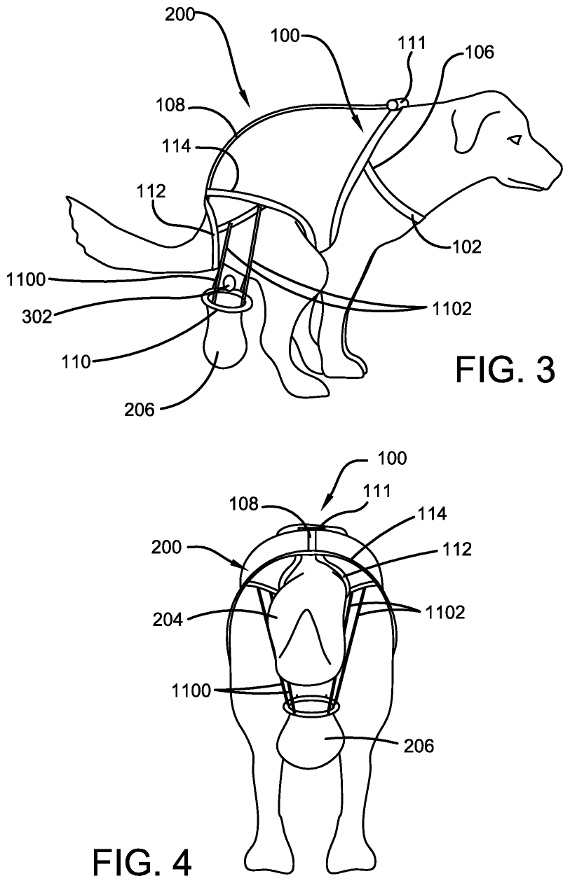

FIG. 3 illustrates a perspective view showing a disposable plastic bag 206 attached to the waste collection holder 110 receiving dog waste 302 in accordance with the disclosed architecture. When a dog 200 squats to defecate in an open area, the disposable plastic bag 206 attached to the waste collection holder 110 of the waste collection harness 100 is positioned directly underneath the anus for the excrement 302 to drop directly into the plastic bag 206. The plastic bag 206 can easily be attached and detached from the collection holder 110.

The plastic bag 206 and holder 110 does not impede the walk and movement of the dog 200. The bag 206 collects pet waste before it hits the ground and reduces the risk of unsanitary material getting on the hands of pet owners while walking a pet. Further, the disposable bags 206 can come in packages containing up to 30 disposable bags 206. The bag 206 is leak-proof and fits well within the holder 110. The disposable bag 206 can be translucent or opaque. The invented device 100 of the present disclosure can be available as a dog harness and a packet of compatible plastic bags that attach to the holder configured to be positioned under the anus of a dog to catch the falling excrement of the dog.

The harness 100 fits snugly and comfortably, and remains correctly-positioned to collect the dog's excrement. Further, the harness 100 is adjustable and can be resized to fit pets of various sizes and dimensions. The harness 100 of the present invention eliminates the need for a pet owner to carry a separate poop scooper device while walking with the dog. The harness and the plastic bag can be attached before starting a walk, thus eliminating the need to carry the plastic bags on each outing.

In one embodiment of the present invention, the waste bag holder is detachable from the harness and can also be available as a standalone product. The waste bag holder with the integrated arms can be attached to the rear portion of any conventional harness using a mechanical fastener or hook and loop fastener. The waste bag holder, once attached, does not impede the walking gait of a dog.

FIG. 4 illustrates a rear perspective view of a pet wearing the harness with waste-collecting holder for receiving dog waste in accordance with the disclosed architecture. The holder 110 is hung securely using the integrated straps 1100, 1102 such that the holder 110 is positioned under the anus and does not impede the walking gait of the pet/dog 200. The dog's tail 204 naturally moves out of the way of the holder 110 while the dog 200 poops in the squatted position. A plastic bag 206 fastened to the holder 110 collects the waste and prevents same from hitting the ground.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dog waste collection harness”, “harness”, “waste collection harness”, and “dog harness” are interchangeable and refer to the dog waste collection harness 100 of the present invention.

Notwithstanding the forgoing, the dog waste collection harness 100 of the present invention can be of any suitable size and configuration as is known in the art without affecting the overall concept of the invention, provided that it accomplishes the above-stated objectives. One of ordinary skill in the art will appreciate that the size, configuration, and material of the dog waste collection harness 100 as shown in the FIGS. are for illustrative purposes only, and that many other sizes and shapes of the dog waste collection harness 100 are well within the scope of the present disclosure. Although the dimensions of the dog waste collection harness 100 are important design parameters for user convenience, the dog waste collection harness 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet harness configured to provide a support structure for a waste collection holder for a pet, the pet harness comprising:
a shoulder strap for retention around a neck and a shoulder area of the pet;
a back strap connected to said shoulder strap and extending along a back of a pet;
a rear strap connected to said back strap for retention around a pair of rear leg thighs and a rear end of the pet;
a tail strap connected to said back strap and said rear strap for circumscribing around a tail of the pet for centering said rear strap; and
a pair of selectively removable retention straps connected to said rear strap for retention of the waste collection holder.

2. The pet harness of claim 1, wherein said waste collection holder is centered under an anus of the pet when the pet is in a squat position to defecate.

3. The pet harness of claim 2, wherein said waste collection holder comprises a flexible receptacle attached thereto.

4. The pet harness of claim 3, wherein said waste collection holder retains said flexible receptacle in an open position.

5. The pet harness of claim 4, wherein said flexible receptacle is a plastic bag.

6. The pet harness of claim 5, wherein said waste collection holder includes a hook and loop fastener for attachment of said plastic bag.

7. The pet harness of claim 5, wherein said waste collection holder includes a clip for attachment of said plastic bag.

8. The pet harness of claim 5, wherein said plastic bag contains an excrement of the pet after defecation.

9. The pet harness of claim 2, wherein said shoulder strap comprises at least one flexible arm for connecting said shoulder strap to said back strap.

10. The pet harness of claim 2, wherein said back strap includes a handle for grasping to restrain the pet.

11. A pet harness configured to provide a support structure for a waste collection holder for a pet, the pet harness comprising:
a shoulder strap for retention around a neck and a shoulder area of the pet;
a back strap connected to said shoulder strap and extending along a back of the pet;
a rear strap connected to said back strap for retention around a pair of rear leg thighs and a rear end of the pet;
a tail strap connected to said back strap and said rear strap for circumscribing around a tail and the rear end of the pet for centering said rear strap on the pet;
a first pair of selectively removable retention straps connected to said rear strap for retention of the waste collection holder; and
a second pair of selectively removable retention straps connected to said rear strap for retention of said waste collection holder.

12. The pet harness of claim 11, wherein said waste collection holder is centered under an anus of the pet when the pet is in a squat position to defecate.

13. The pet harness of claim 12, wherein said waste collection holder comprises a flexible receptacle attached thereto.

14. The pet harness of claim 13, wherein said waste collection holder retains said flexible receptacle in an open position.

15. The pet harness of claim 14, wherein said flexible receptacle is a plastic bag.

16. The pet harness of claim 15, wherein said waste collection holder includes a hook and loop fastener for attachment of said plastic bag.

17. The pet harness of claim 15, wherein said waste collection holder includes a clip for attachment of said plastic bag.

18. The pet harness of claim 15, wherein said plastic bag contains an excrement of the pet after defecation.

19. The pet harness of claim 12, wherein said shoulder strap comprises at least one flexible arm for connecting said shoulder strap to said back strap.

20. A dog harness configured to provide a support structure for a waste collection holder on a dog, the dog harness comprising:
a shoulder strap for retention around a neck and a shoulder area of the dog;
a back strap connected to said shoulder strap and extending along a back of the dog;
a rear strap connected to said back strap for retention around a pair of rear leg thighs and a rear end of the dog; and
a pair of selectively removable retention straps connected to said rear strap for retention of the waste collection holder, wherein said waste collection holder comprises a plastic bag, and further wherein said waste collection holder retains said plastic bag in an open position.
